(19) United States
(12) Patent Application Publication
(10) Pub. No.: US 2017/0359511 A1
(43) Pub. Date: Dec. 14, 2017

(54) IMAGE CAPTURING DEVICE CAPABLE OF INTERMITTENTLY CAPTURING IMAGES OF SUBJECT, CONTROL METHOD FOR THE SAME, AND PROGRAM

(71) Applicant: CANON KABUSHIKI KAISHA, Tokyo (JP)

(72) Inventor: Masao Okada, Kawasaki-shi (JP)

(21) Appl. No.: 15/616,360

(22) Filed: Jun. 7, 2017

(30) Foreign Application Priority Data
Jun. 8, 2016 (JP) 2016-114804

(51) Int. Cl. H04N 5/232; H04N 5/06; H04N 5/445; H04N 9/73; H04N 5/235

(52) U.S. Cl. CPC H04N 5/23232; H04N 5/23245; H04N 5/06; H04N 5/44504; H04N 5/23296; H04N 5/23212; H04N 5/2353; H04N 9/735

(57) ABSTRACT

An image capturing device capable of intermittent image capture, based on a predetermined given timing, to acquire multiple first images includes a detecting unit, an acquiring unit, and a setting unit. The detecting unit detects at least either a zooming operation or a panning operation that is performed when an image of a subject is captured. The acquiring unit causes a second image to be acquired in accordance with the zooming operation or the panning operation when at least either the zooming operation or the panning operation has been detected. The setting unit sets the second image as an image corresponding to at least one frame forming a time-lapse motion picture when at least either the zooming operation or the panning operation has been detected. The second image is acquired at a different timing from the given timing for acquiring the first images.

### BACKGROUND

### Field

The present disclosure relates to an image capturing device capable of intermittent image capture, a control method for the image capturing device, and a program.

### Description of the Related Art

Conventionally, there is known a technology of intermittently capturing images of a subject (so-called interval shooting). There is known a technology of acquiring a moving image (a so-called time-lapse motion picture) by combining multiple images acquired through the interval shooting.

During the above-described acquisition of a time-lapse motion picture (during the intermittent image capture), if the angle of view is changed by a user performing a zooming operation or something, there may be an image with a suddenly-changed angle of view in the acquired time-lapse motion picture. This is concretely explained below.

FIGS. 6A and 6B are diagrams illustrating an example of a change in the angle of view during the acquisition of a time-lapse motion picture; FIG. 6A illustrates the case in which a zooming operation is performed during the acquisition of a time-lapse motion picture. As shown in FIG. 6A, for example, if a zooming operation was performed in an interval between the (t+1)th image capture (t is a natural number) and the (t+2)th image capture in the acquisition of the time-lapse motion picture, the angle of view varies between images acquired in the (t+1)th and (t+2)th image captures. In this case, in the time-lapse motion picture generated by using multiple images with different angles of view, the angle of view changes suddenly, which gives a feeling of strangeness to a user who is viewing the time-lapse motion pictures.

In Japanese Patent Laid-Open No. 2015-61235, there is suggested a technology of detecting a change in the angle of view in the generation of a time-lapse motion picture and using a constituent frame image acquired by trimming a shot image in the generation of the time-lapse motion picture according to the change in the angle of view.

### SUMMARY

In various embodiments, an image capturing device includes an image capturing unit and is able to set a mode to perform intermittent image capture, based on a predetermined given timing, to acquire multiple first images used for generation of a time-lapse motion picture. In various embodiments, the image capturing device includes a detecting unit, an acquiring unit, and a setting unit. The detecting unit is configured to detect at least either a zooming operation or a panning operation that is performed when an image of a subject is captured in the mode. The acquiring unit is configured to cause the image capturing unit to acquire a second image in accordance with the zooming operation or the panning operation when the detecting unit has detected at least either the zooming operation or the panning operation. The setting unit is configured to set the second image as an image corresponding to at least one frame forming the time-lapse motion picture when the detecting unit has detected at least either the zooming operation or the panning operation in the mode. The second image is acquired at a different timing from the given timing for acquiring the first images.

Further features will become apparent from the following description of exemplary embodiments (with reference to the attached drawings).

### BRIEF DESCRIPTION OF THE DRAWINGS

FIG. 1 is a block diagram showing a configuration example of a digital camera that is an embodiment of an image capturing device according to one embodiment.

FIG. 2 is a diagram illustrating the back side of the camera according to one embodiment.

FIG. 3 is a flowchart explaining an image capturing process in time-lapse mode of the camera according to one embodiment.

FIG. 4 is a flowchart explaining a moving-image generating process performed by the camera according to one embodiment.

FIGS. 5A and 5B are diagrams illustrating an example of frames in a time-lapse motion picture according to one embodiment.

FIGS. 6A and 6B are diagrams illustrating an example of a change in the angle of view during the acquisition a time-lapse motion picture according to one embodiment.

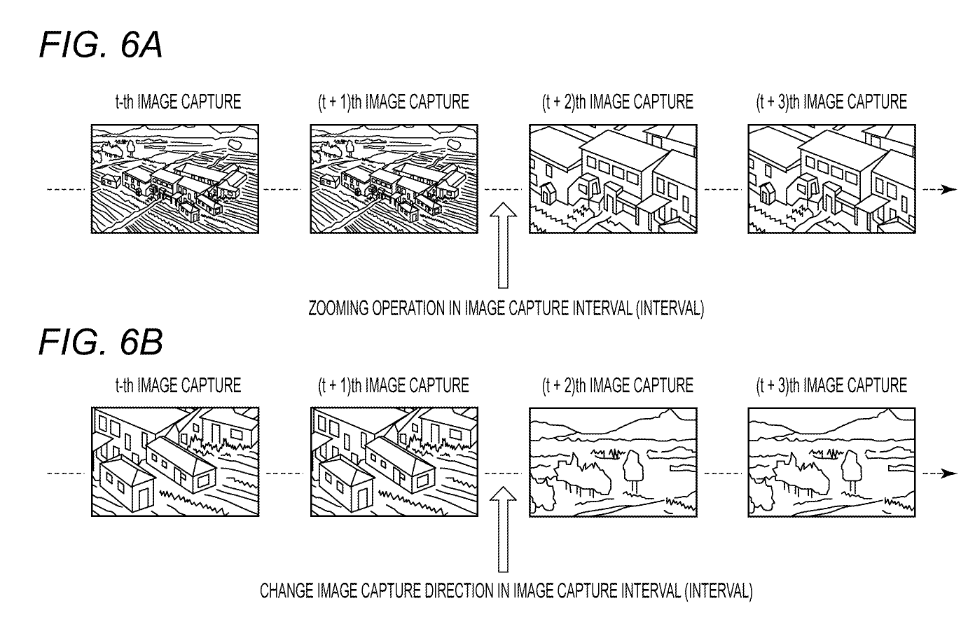

### DESCRIPTION OF THE EMBODIMENTS

### Embodiment

### (Basic Configuration of Digital Camera)

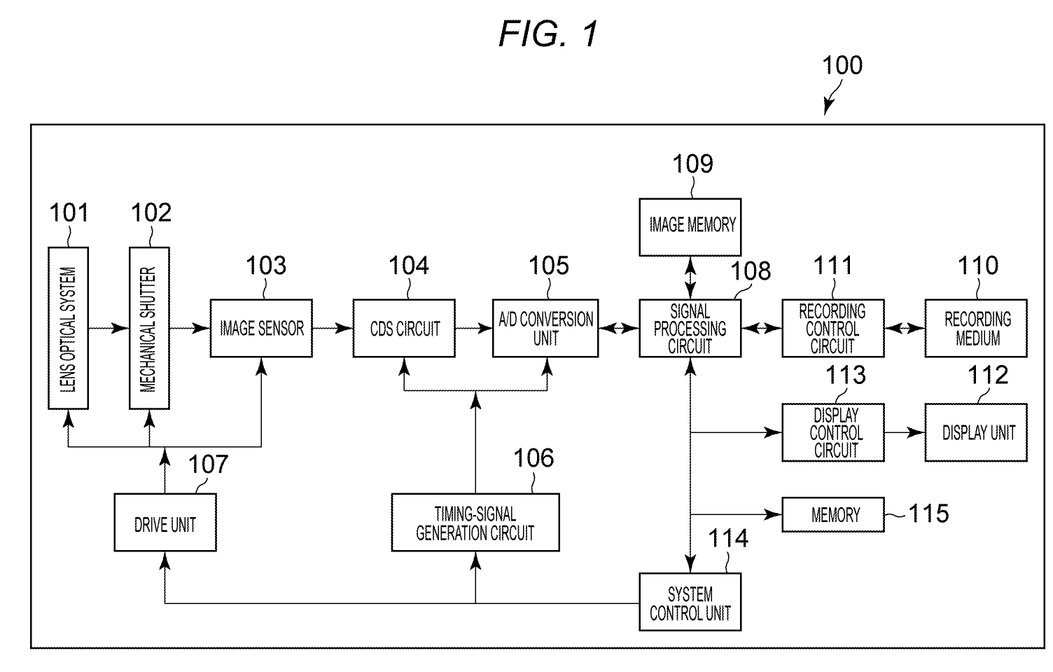

A preferred embodiment is described below on the basis of accompanying drawings. FIG. 1 is a block diagram showing a configuration example of a digital camera (hereinafter, referred to simply as “camera”) 100 that is an embodiment of an image capturing device according to the present disclosure. Incidentally, one or more of functional blocks shown in FIG. 1 can be realized by hardware such as an ASIC or a programmable logic array (PLA), or can be realized by a programmable processor, such as a CPU or an MPU, executing software. Furthermore, the one or more of functional blocks can be realized by a combination of software and hardware. Therefore, in the following description, even when a different functional block is described as an agent of action, the same hardware can be realized as an agent.

As shown in FIG. 1, a lens optical system 101 is optical members including a focus lens, a zoom lens, a shift lens, etc. A mechanical shutter 102 is a light-shielding member for opening an optical path between the lens optical system 101 and an image sensor 103 and shielding the optical path from light. The image sensor 103 is a charge accumulation type solid-state image sensing device such as a CCD or a CMOS, and is an image capturing unit that generates analog image data by photoelectrically converting a light flux from a subject that has entered through the lens optical system 101 (capturing an image of the subject).

A CDS circuit 104 is a correlative double sampling, unit for removing reset noise related to the accumulation and readout of electric charge in the image sensor 103. An A/D conversion unit 105 is a conversion unit that converts the analog image data output from the image sensor 103 into digital image data. A signal processing circuit 108 is an image processing unit that performs various processes, such white balance adjustment and tone processing, on the digital image data output from the A/D conversion unit 105.

A timing-signal generation circuit 106 is a timing signal generating unit that generates signals for activating various parts of the camera 100, such as the CDS circuit 104 and the A/D conversion unit 105. A drive unit 107 is a drive unit (a drive circuit) that drives the lens optical system 101, the mechanical shutter 102, and the image sensor 103, and can activate a unit connected to any of these in accordance with an instruction from a system control unit 114 to be described later.

An image memory 109 is an image storage unit that stores therein imaged data output from the signal processing circuit 108. A recording medium 110 is an external recording unit that can be removably attached to the camera 100, and is controlled by a recording control circuit 111, and can record thereon signal-processed image data. Incidentally, the recording medium 110 can also record thereon image data temporarily stored in the image memory 109. A display unit 112 is a display unit that is controlled by a display control circuit 113 and displays thereon display analog image data converted by a D/A conversion unit (not shown).

The system control unit 114 is a control unit that controls the operation of the camera 100 comprehensively, and includes a CPU for the control therein. Specifically, the system control unit 114 instructs the drive unit 107 or the timing-signal generation circuit 106 to perform the exposure control or the focus control in the camera 100.

A memory 115 is a storage unit capable of electrically erasing and storing data, such as an EEPROM typified by a flash memory or the like, and includes a RAM area and a ROM area. On this memory 115, various data related to the operation of the camera 100, such as various operational expressions and table data used for the focus control and the exposure control, have been recorded in advance, and various data acquired by the camera 100 can be recorded.

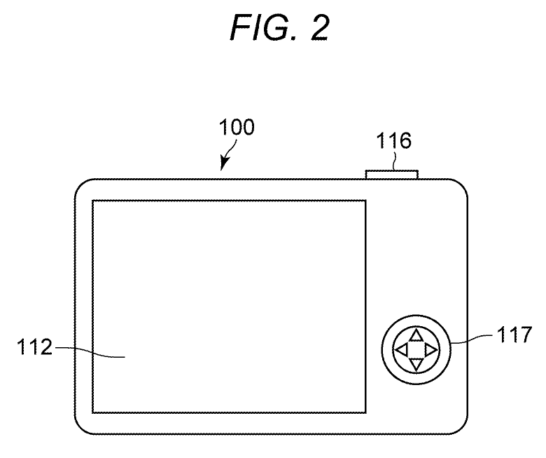

FIG. 2 is a diagram illustrating the back side of the camera 100 that is an image capturing device according to one embodiment. The above-described display unit 112 is provided on the back side of the camera 100 as shown in FIG. 2, and the lens optical system 101 is provided on the other side.

Furthermore, as shown in FIG. 2, a release switch 116 is provided on top of the camera 100; the release switch 116 is for inputting a start signal for an image capturing operation to the system control unit 114 on the basis of user's manual operation. When the release switch 116 is pressed halfway (an SW1 state), a start signal for an image capture preparing operation can be input; when the release switch 116 is pressed fully (an SW2 state), a start signal for an actual image capturing operation can be input.

Moreover, an operation unit 117 is provided on the back side of the camera 100; the operation unit 117 is for inputting various operation signals to the system control unit 114 on the basis of user's manual operation. For example, the user can set an image capture mode to be described later by operating the operation unit 117. The above are the basic configurations of the camera 100 according to various embodiments.

### (Image Capturing Process)

How to capture an image of a subject using the camera 100 is explained below. First, when a user has pressed the release switch 116 in a state where the units of the camera 100 are supplied with power, the camera 100 starts the operation to capture an image of a subject. In this image capturing operation, first, in an image capture preparing operation, the exposure control or the focus control are performed, and then actual image capture (an actual image capturing operation) is performed.

First, the mechanical shutter 102 is retracted from the optical path, and a light flux entering through the lens optical system 101 is focused onto the image sensor 103. Then, the image sensor 103 is shielded from light by driving the mechanical shutter 102 in accordance with the operation of the image sensor 103 so that it takes a necessary exposure time based on a control signal from the system control unit 114. Incidentally, if the image sensor 103 has a so-called electronic shutter function, it can be configured to control the exposure time in conjunction with the mechanical shutter 102.

The image sensor 103 is driven on the basis of an operation pulse generated by the timing-signal generation circuit 106, and photoelectrically converts the subject image into an electrical signal and outputs the electrical signal as analog image data (signal). The analog image data output from the image sensor 103 is subjected to the removal of clock-synchronous noise by the CDS circuit 104 on the basis of an operation pulse generated by the timing-signal generation circuit 106. Then, the analog image data with the noise removed is converted into digital image data (signal) by the A/D conversion unit 105.

Then, the digital image data output from the A/D conversion unit 105 is subjected to image processing, such as color conversion, white balance adjustment, and gamma correction, resolution conversion processing, image compression processing, etc. by the signal processing circuit 108. Incidentally, the A/D converted image data can be directly output to the image memory 109 or the recording control circuit 111 without being subjected to various processing by the signal processing circuit 108.

Here, the above-mentioned image capture preparing operation of the camera 100 is explained. The system control unit 114 acquires the brightness of a subject corresponding to image data acquired by using the image sensor 103 on the basis of the image data. Specifically, the system control unit 114 divides the acquired image data into a plurality of blocks, and calculates the average brightness of each block. Then, the system control unit 114 integrates respective values of average brightness of the blocks and acquires the representative brightness. This representative brightness is the brightness actually measured on the basis of the acquired image data, and is used for the exposure control when an image of the subject is captured. Incidentally, the method to calculate the representative brightness (the measured brightness) is not limited to this, and other publicly-known methods can be adopted. Furthermore, in the present embodiment, there is described the configuration in which the brightness is acquired on the basis of image data acquired by using the image sensor 103; however, it can be configured to acquire the brightness by using a so-called photometric sensor (not shown) or the like provided besides the image sensor 103.

Then, the system control unit 114 performs the exposure control on the basis of the acquired brightness. Specifically, the system control unit 114 performs the exposure control by changing the exposure by a difference between the target brightness corresponding to the appropriate brightness that has been recorded on the memory 115 in advance and the acquired brightness.

Furthermore, the system control unit 114 calculates the distance from the camera 100 to the subject (the subject distance), and performs the control of moving the lens position of the focus lens of the lens optical system 101 to a focusing position on the basis of the subject distance (the focus control). Incidentally, in the present embodiment, the AF control is performed on the basis of contrast information of image data acquired by shifting the position of the focus lens of the lens optical system 101; however, the present disclosure is not limited to this embodiment. For example, various embodiments can be configured to calculate the subject distance by using the phase difference detection method.

Furthermore, there is described a playback operation when image data has been recorded on the recording medium 110. First, the recording control circuit 111 reads out the image data recorded on the recording medium 110 on the basis of a control signal from the system control unit 114.

Furthermore, the signal processing circuit 108 performs an image decompressing process on the image data, for example, if the image data has been compressed on the basis of a control signal from the system control unit 114. The decompressed image data is stored in the image memory 109. Then, after the image data stored in the image memory 109 is subjected to resolution conversion processing by the signal processing circuit 108, the image data is controlled by the display control circuit 113 to be converted into a signal suitable for the display unit 112 and displayed on the display unit 112.

### (Image Capture Mode)

The image capture mode that can be set in the camera 100 is explained below. The camera 100 in the present embodiment can be set in normal still image mode, normal moving image mode, or time-lapse mode as an image capture mode. Incidentally, the camera 100 in the present embodiment can be configured to be able to set an image capture mode other than the above-described modes.

The normal still image mode is an image capture mode in which one image data (still image) for recording is acquired. The normal moving image mode is an image capture mode which a moving image is acquired by combining multiple pieces of image data acquired by using the image sensor 103 in order. In this case, the multiple pieces of image data are images corresponding to frames forming the moving image. The time-lapse mode is an image capture mode in which intermittent image capture is performed to acquire a moving image (a time-lapse motion picture) that multiple pieces of image data acquired by performing intermittent image capture are combined in order. Incidentally, in the time-lapse mode, the camera 100 in the present embodiment performs the intermittent image capture based on the predetermined given timing and the image capture according to a given operation made on the camera 100. Then, multiple pieces of image data acquired through the image capture shall be image data corresponding to frames forming a time-lapse motion picture.

Incidentally, the normal moving image mode and the time-lapse mode differ in the number of charge accumulations for recording using the image sensor 103 (or the number of charge resets) within a given time. In the camera 100 in the present embodiment, the number of charge accumulations for recording performed in the same period of time is smaller in the time-lapse mode than that in the normal moving image mode. Therefore, in the normal moving image mode, the time to acquire one moving image and the time to play back the acquired moving image are about the same; on the other hand, in the time-lapse mode, the time to play back one moving image is shorter than the total image capture time to acquire the moving image. By this configuration, a time-lapse motion picture acquired in the time-lapse mode can be recorded and played back with temporal changes of the subject compressed.

Incidentally, in the time-lapse mode, as the preset given timing (first timing), a user can set an arbitrary image capture interval from given image capture intervals (first image capture intervals) of, for example, 1 second, 30 seconds, 1 minute, 15 minutes, 30 minutes, 1 hour, 3 hours, 5 hours, 10 hours, and 24 hours. Incidentally, it can be configured that a user can freely set an image capture interval other that the preset time intervals if it can be determined before the start of the acquisition of a time-lapse motion picture. For example, it can be configured to set an image capture interval shorter than 1 second.

Furthermore, in the above-described time-lapse mode, the total image capture time to perform intermittent image capture or the total number of image captures can be set. Moreover, the camera 100 in the present embodiment can perform intermittent image capture unlimitedly as long as power of a battery (not shown) provided in the camera 100 lasts, without setting the total image capture time or the total number of image captures. The above-described image capture modes can be freely set by a user operating the operation unit 117.

### (Time-Lapse Mode)

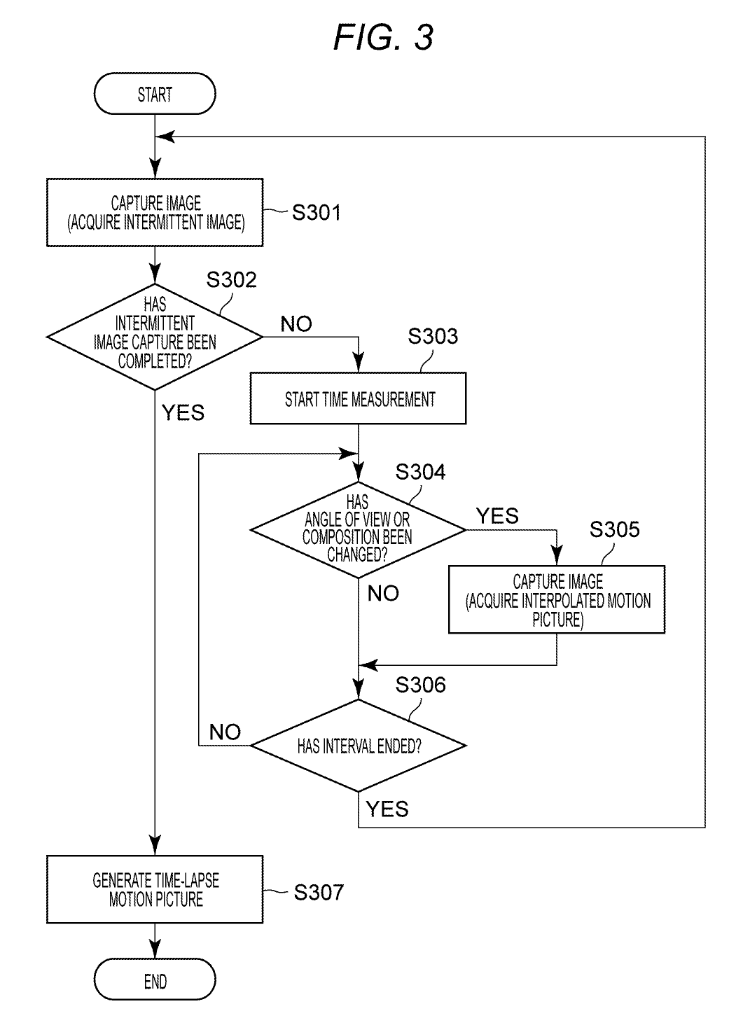

An image capturing process in the time-lapse mode in the present embodiment is explained below with reference to FIG. 3. FIG. 3 is a flowchart explaining the image capturing process in the time-lapse mode of the camera 100. Incidentally, the image capture interval and the total number of image captures or the total image capture time in the time-lapse mode shall be set by a user in advance.

In the time-lapse mode, when an instruction to start image capture has been issued, an image capturing process is started. First, at step S301, the system control unit 114 performs the above-described image capturing operation including the image capture preparing operation, thereby capturing an image of a subject and acquires an image for recording. The image acquired at step S301 is the image intermittently acquired at an image capture interval set in advance (referred to as an “intermittent image”). Then, the intermittent image is the image predetermined to be acquired in the time-lapse mode, and is set as an image corresponding to each of frames forming a time-lapse motion picture regardless of with or without a change in the angle of view due to a zooming operation to be described later or a change in the composition (when an image is captured) due to a panning operation.

The acquired intermittent image is recorded on the image memory 109 or the like with information such as the image capture order associated as metadata in accordance with an instruction from the system control unit 114. At this time, the acquired intermittent image can be configured to be displayed on a quick review display of the display unit 112.

Here, the timing to perform each image capture (actual image capture) in the intermittent image capture (the first timing) shall be controlled by the system control unit 114 on the basis of the preset image capture interval. Furthermore, according to the completion of the actual image capture, the system control unit 114 resets the time measurement related to the image capture interval by a timer (not shown). The timer is a so-called real-time clock, and can measure the time in the time-lapse mode.

Then, at step S302, the system control unit 114 detects whether the current number of image captures has reached the total number of image captures or whether the current image capture time has reached the total image capture time, thereby determining whether or not the intermittent image capture has been completed. When having determined that the intermittent image capture has been completed, the system control unit 114 goes on to step S307. On the other hand, when having determined that the intermittent image capture has not been completed, the system control unit 114 goes on to step S303.

At step S303, the system control unit 114 starts the time measurement using the timer an the basis of the preset image capture interval (the first image capture interval). Then, at step S304, the system control unit 114 determines whether or not the angle of view and the image capture frame when an image is captured has been changed in the image capture interval. In the present embodiment, when as an operation related to a change in the angle of view or a change in the composition (referred to as a “frame-changing operation”), at least either a zooming operation or a panning operation has been detected, the angle of view or the composition is assumed to have been changed.

Here, the above-described frame-changing operation is explained. In the present embodiment, a zooming operation and an operation to change the direction of the camera (the image capturing direction) fall under the frame-changing operation. Specifically, when it has been detected that a zooming operation member (not shown) has been operated, the system control unit 114 determines that the angle of view has been changed. That is, a zooming operation (the reduction and enlargement of the angle of view) performed by a user is included in the frame-changing operation. Furthermore, when a change in the image capturing direction has been detected on the basis of results of detection by a posture detecting unit and a movement detecting unit of the camera 100, the system control unit 114 determines that the composition has been changed. That is, for example, a change in the direction of the camera 100 (the image capturing direction) due to panning or something is included in the frame-changing operation.

Incidentally, as the zooming operation, it can be an operation using the operation unit 117, or, if the display unit 112 doubles as an operation unit such as a touch panel, it can be an operation using the display unit 112. Furthermore, a so-called gyro sensor (not shown) or the like is adopted as the posture detecting unit, and a so-called angular velocity sensor (not shown) or the like is adopted as the movement detecting unit.

In the present embodiment, it is configured to detect a change in the angle of view or the composition in conjunction with the detection of at least either a zooming operation or an operation to change the image capturing direction; however, the present disclosure is not limited to this configuration. For example, it can be configured to detect a change in the angle of view or the composition on the basis of a motion picture other than those described above, such as digital zoom or trimming of a playback image.

When a change in the angle of view or the composition has been detected, at step S305, the system control unit 114 controls the operation of each of the units composing the camera 100, such as the image sensor 103, so as to perform image capture in a period of time in which the change in the angle of view or the change in the composition has been detected (the image capture control). Then, the system control unit (an acquiring unit) 114 records the change in the angle of view or the change in the composition on the basis of the image capture control, thereby acquiring an image that a change of a subject of which the angle of view and the composition are changing is interpolated and recorded thereon (hereinafter, referred to as an “interpolated image”).

The above-described interpolated image is the image set as an image used to generate a time-lapse motion picture when the change in the angle of view or the change in the composition has been detected in the time-lapse mode. In the present embodiment, the image capture is performed continuously in an image capture interval (a second interval) shorter than the image capture interval in which an intermittent image is acquired (the first interval), thereby acquiring an interpolated motion picture based on multiple interpolated images. Then, the acquired interpolated motion picture is recorded on the image memory 109 or the like with information on the timing at which the intermittent images have been acquired in the intermittent image capture associated as metadata in accordance with an instruction from the system control unit 114. As the metadata, specifically, information on the position to which the interpolated motion picture is inserted on the intermittently acquired intermittent images on the basis of the timing at which the change in the angle of view or the change in the composition has been detected (the second timing) is associated.

Incidentally, in a first configuration in which a change in the angle of view or a change in the composition in the image capture interval in the intermittent image capture overlaps with the next image capture timing in the intermittent image capture, the acquisition of an interpolated motion picture (interpolated images) is ended just before the start of the next intermittent image capture. In this case, even while the angle of view or the composition is changing, the acquisition of an intermittent image is ended in accordance with the next intermittent image capture. Furthermore, in a second configuration in which a change in the angle of view or a change in the composition in the image capture interval in the intermittent image capture overlaps with the next image capture timing in the intermittent image capture, after the completion of the change in the angle of view or the change in the composition (after any change in the angle of view or any change in the composition have not been detected), the next intermittent image capture is performed. In this case, the change in the angle of view or the change in the composition is given preference, and the timing of the next intermittent image capture is shifted. Switching between the first configuration and the second configuration is performed, for example, in such a manner that the first configuration is preferentially adopted if the total image capture time has been set in the time-lapse mode, and the second configuration is preferentially adopted if the total number of image captures has been set. This configuration can automatically determine whether the length of a time-lapse motion picture is given preference or recording a change in the angle of view or a change in the composition is given preference and generate a time-lapse motion picture based on user's intention. Incidentally, switching between the first configuration and the second configuration can be configured to be set on the basis of a user's arbitrary operation. As described above, in either case where any configuration is adopted, the timing to acquire an intermittent image (a first image) is different from the timing to acquire an interpolated image (a second image).

Then, after the process at step S305 or when it has been determined at step S304 that the angle of view has not been changed, at step S306, the system control unit 114 determines whether or not the time measurement in the current image capture interval has ended (the current interval has ended). That is, the system control unit 114 determines whether or not the time measured by the timer has reached the timing of the next image capture (actual image capture) in the intermittent image capture. When it has been determined that the interval has not ended, returning to step S304, the above-described process at step S304 is repeated. On the other hand, when it has been determined that the interval has ended, returning to step S302, the next actual image capture is performed to acquire an intermittent image.

Then, when the system control unit 114 has determined that the intermittent image capture has been completed, at step S307, the system control unit (a motion-picture generating unit) 114 generates a time-lapse motion picture by combining the acquired images. The detail of this is described later. Then, the system control unit 114 records the generated motion picture on the recording medium 110 or something, and ends the image capturing process.

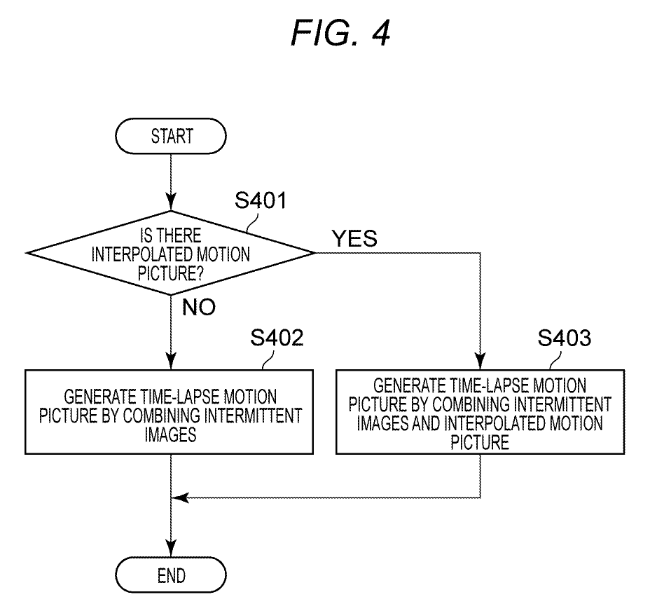

Subsequently, the detail of the process of generating a time-lapse motion picture (hereinafter, referred to as “moving-image generating process”) is explained with FIG. 4. FIG. 4 is a flowchart explaining the moving-image generating process performed by the camera 100. When the moving-image generating process has been started on the basis the above-described process at step S307, at step S401, the system control unit 114 determines whether or not an interpolated motion picture has been recorded on the image memory 109. In other words, the system control unit 114 determines whether or not the angle of view has been changed in the image capture interval in the intermittent image capture in the time-lapse mode. When having determined that an interpolated motion picture is not included in the image memory 109, the system control unit 114 goes on to step S402; on the other hand, when having determined that an interpolated motion picture is included in the image memory 109, the system control unit 114 goes on to step S403.

Then, at step S402, the system control unit (the motion-picture generating unit) 114 generates a time-lapse motion picture by combining (connecting) the acquired intermittent images in the image capture order on the basis of metadata associated with the images.

Furthermore, at step S403, the system control unit (the motion-picture generating unit) 114 generates a time-lapse motion picture by combining (connecting) the acquired intermittent images and interpolated images in the image capture order on the basis of metadata associated with the images.

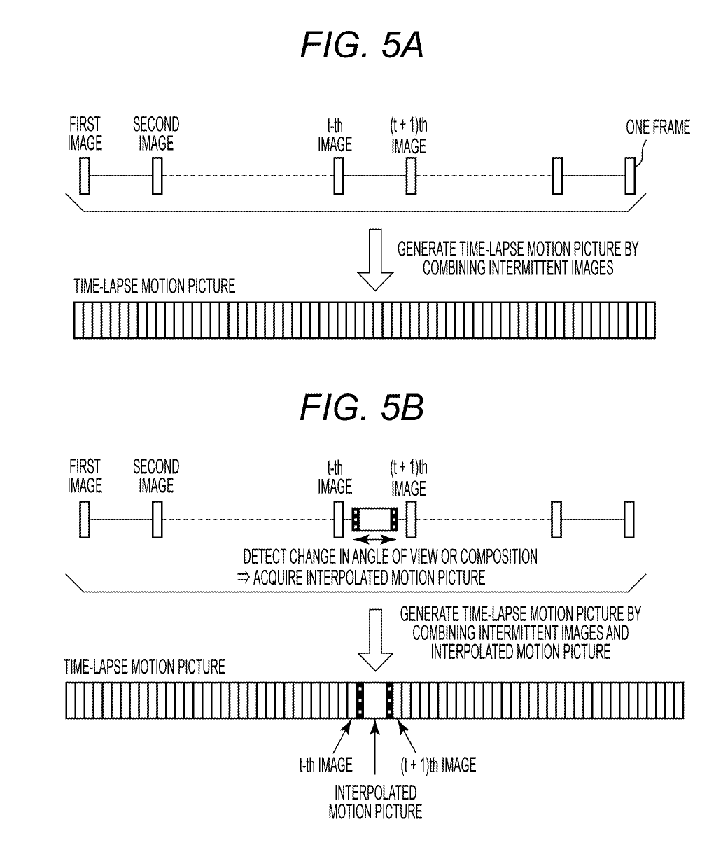

FIGS. 5A and 5B are diagrams illustrating an example of frames in a time-lapse motion picture according to one embodiment. FIG. 5A is a diagram illustrating an example of a time-lapse motion picture acquired when the angle of view has not changed in the image capture interval in the time-lapse mode. In this case, the angle of view has not changed in the image capture interval, so no interpolated images have been acquired. Therefore, the system control unit (a setting unit) 114 sets only the intermittent images acquired in the intermittent image capture as images for generating a time-lapse motion picture. Then, the system control unit 114 generates a time-lapse motion picture by combining the set intermittent images.

On the other hand, FIG. 5B is a diagram illustrating an example of a time-lapse motion picture acquired when the angle of view has changed in the image capture interval in the time-lapse mode. In this case, the system control unit (the setting unit) 114 sets the intermittent images acquired in the intermittent image capture and an interpolated motion picture (interpolated images) as images for generating a time-lapse motion picture. Then, the system control unit 114 generates a time-lapse motion picture by combining the set intermittent images and interpolated motion picture. The above is the moving-image generating process according to the present embodiment.

Incidentally, the interpolated motion picture (interpolated images) is added with metadata showing which intermittent images in multiple intermittent images acquired in the intermittent image capture the interpolated motion picture was acquired between. In other words, metadata showing the timing at which the angle of view was changed in the intermittent image capture is recorded in the interpolated motion picture (interpolated images).

For example, as shown in FIG. 5B, in the intermittent image capture, between the t-th image acquired in the t-th image capture (a first image capture) and the (t+1)th image acquired in the (t+1)th image capture (a second image capture) which are in communication, an interpolated motion picture is acquired according to the change in the angle of view. This interpolated motion picture is added with above-described metadata. Therefore, the system control unit 114 generates the time-lapse motion picture by inserting the interpolated motion picture in between (a frame corresponding to) the t-th intermittent image and (a frame corresponding to) the (t+1)th intermittent image.

As described above, the camera 100 in the present embodiment is configured to acquire an interpolated motion picture when the angle of view or the composition has been changed in the image capture interval in the time-lapse mode and use the interpolated motion picture for the generation of a time-lapse motion picture, i.e., as an image corresponding to a frame forming the time-lapse motion picture. By this configuration, even if there is a major change in the angle of view or the composition, the camera 100 in the present embodiment can acquire a time-lapse motion picture in which the change of a subject is smooth. Therefore, a user can view to time-lapse motion picture in which the change in the angle of view or the change in the composition is smoothly recorded.

Various embodiments are described above; however, the present disclosure is not limited to these embodiments, and various modifications and alterations can be made without departing from the scope of this disclosure. For example, in the above-described embodiment, in the time-lapse mode, the camera 100 is configured to generate a time-lapse motion picture internally; however, the present disclosure is not limited to this configuration. That is, other embodiments can be configured so that the camera 100 performs the intermittent image capture (the interval shooting) for acquiring images used for the generation of a time-lapse motion picture, and a time-lapse motion picture is generated by an external device or on a computer network.

Furthermore, in the above-described embodiment, the camera 100 is configured to acquire an interpolated motion picture when detecting a change in the angle of view or a change in the composition in the image capture interval in the time-lapse mode; however, the camera 100 can be configured to acquire not a motion picture but multiple interpolated images in other embodiments. Moreover, the camera 100 can be configured to change the length of an interpolated motion picture acquired, i.e., the number of interpolated images according to the period of time in which the angle of view or the composition is changed. That is, in various embodiments, the camera 100 can be configured to acquire an interpolated image corresponding to at least one frame forming a time-lapse motion picture when a change in the angle of view or the composition has been detected.

Moreover, in the above-described embodiment, the camera 100 is configured to acquire an interpolated motion picture according to the detection of a change in the angle of view or a change in the composition in the image capture interval in the time-lapse mode; however, the present disclosure is not limited to this configuration. For example, in various embodiments, the camera 100 can be configured that the system control unit (a determining unit) 114 determines whether or not the amount of change in the angle of view or the composition is larger than a predetermined value and, if having determined that the amount of change in the angle of view or the composition is larger than the predetermined value, performs the image capture for acquiring interpolated images (an interpolated motion picture). That is, in various embodiments, the camera 100 can be configured to acquire interpolated images if the amount of zooming operation or the amount of panning operation is larger than a predetermined value and not to acquire interpolated images if the amount of zooming operation or the amount of panning operation is equal to or smaller than the predetermined value. For example, when a user shakes the camera 100 unintentionally, or when the user adjusts the angle of view intentionally, this configuration can prevent the insertion of interpolated images, so that a user's intended time-lapse motion picture can be acquired more effectively.

Incidentally, the predetermined value can be any value as long as it does not make the change in the angle of view or the change in the composition look unnatural in the frame transition in the time-lapse motion picture. For example, the system control unit 114 could set the predetermined value to 10%, and perform control so as not to acquire interpolated images if the amount of change in the angle of view or the composition is 10% or less than the angle of view or the composition before the change. In this case, if the change in magnification due to a zooming operation is 10% or less, or if the amount of change in angular velocity detected by the gyro sensor due to a panning operation is 10% or less, no interpolated images are acquired.

Furthermore, in various embodiments, the camera 100 can be configured so that a blind zone is provided in the period of time in which a change in the angle of view or a change in the composition is detected, and, when a given time (for example, 3 seconds) has passed since a zooming operation was performed by a user, interpolated images are acquired if the amount of change in the angle of view or the composition before and after the change is larger than the predetermined value. That is, for example, even when there is a change in the angle of view larger than the predetermined value within 3 seconds after the start of the change in the angle of view or the composition, if the amount of change in the angle of view or the composition at 3 seconds after the start of the change in the angle of view or the composition is equal to or smaller than the predetermined value, no interpolated images are acquired. This configuration can prevent a composition adjustment or the like made by a user from being reflected a time-lapse motion picture sequentially.

Moreover, in the above-described embodiment, the camera 100 can be configured so that a user further selects whether or not to acquire interpolated images in the time-lapse mode before the start of the intermittent image capture.

Incidentally, to prevent a decrease in appearance (quality) of a time-lapse motion picture, it is preferable that the change in brightness or the change in the focus position (the focal length) in the time-lapse motion picture makes a smooth transition. Accordingly, in addition to the above-described embodiment, in some embodiments, the system control unit 114 can be configured to further perform control so that respective image capturing conditions (the focus position, exposure, white balance, etc.) on intermittent images and interpolated images (an interpolated motion picture) have continuity with each other. Specifically, in some embodiments, the system control unit 114 sets the focus position, exposure, and white balance when an interpolated image is acquired, in accordance with an intermittent image (before the change in the angle of view or the change in the composition) acquired just before the interpolated image is inserted. Then, the focus position, exposure, and white balance when an intermittent image is acquired just after the insertion of the interpolated image, are adjusted to the interpolated image.

Incidentally, in the above-described embodiment, there is described the configuration in which an image of a subject is captured and acquired at an image capture interval to acquire an image for generating a time-lapse motion picture; however, the present disclosure is not limited to this configuration. For example, the above-described characteristic configuration of various embodiments can also be applied to a configuration in which the acquisition of a moving image occurs continuously from the start of image capture, and an image for a time-lapse motion picture is set (thinned out) on the basis of the image capture interval from multiple images (frames) composing the moving image. In this case, a period of thinning out of the interpolated image according to the change in the angle of view or the change in the composition only has to be shorter than a period of thinning out of the intermittent image from the multiple images.

Furthermore, in the above-described embodiment, the operation of the camera 100 is configured to be controlled by the units composing the camera 100, such as the system control unit 114 and the memory 115, operating in cooperation with each other; however, the present disclosure is not limited to this configuration. For example, a (computer) program in accordance with the above-described flows shown in FIGS. 3 and 4 is stored in the memory 115 in advance. Then, the operation of the camera 100 can be configured to be controlled by the system control unit 114 including a microcomputer or the like executing the program.

Furthermore, the form of the program can be any form, for example, an object code, a program executed by an interpreter, or script data supplied to an OS, as long as it has the functions of the program. Moreover, a recording medium for supplying the program can be, for example, a hard disk, a magnetic recording medium such as a magnetic tape, or an optical/magneto-optic recording medium, but is not limited to these examples.

Furthermore, in the above-described embodiments, a digital camera is described as an example of an image capturing device that embodies various embodiments of the present disclosure; however, the image capturing device should not be interpreted as being limited to a digital camera. Other devices that may act as the image capturing device include, for example, portable devices such as a digital video camera and a smartphone, a wearable terminal, a security camera, etc.

### Another Embodiment

Furthermore, various embodiments can be realized by a process of supplying a program realizing one or more functions described in the above embodiment to a system or apparatus via a network or a storage medium and one or more processors in a computer of the system or apparatus reading and executing the program. Moreover, various embodiments can also be realized by a circuit (for example, an ASIC) realizing the one or more functions.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of or more of the above-described embodiment(s) and/or that includes one or more circuits (e.g., application specific integrated circuit (ASIC)) for performing the functions of tone or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (PD)™), a flash memory device, a memory card, and the like.

While various embodiments have been described above with reference to exemplary embodiments, it is to be understood that the scope of the following claims is to be accorded the broadest interpretation so as to encompass all such modifications and equivalent structures and functions.

This application claims the benefit of Japanese Patent Application No. 2016-114804, filed Jun. 8, 2016, which is hereby incorporated by reference herein in its entirety.

What is claimed is:

1. Am image capturing device including an image capturing unit and being able to set a mode to perform intermittent image capture, based on a predetermined given timing, to acquire multiple first images used for generation of a time-lapse motion picture, the image capturing device comprising:
a detecting unit configured to detect at least either a zooming operation or a panning operation that is performed when an image of a subject is captured in the mode;
an acquiring unit configured to cause the image capturing unit to acquire a second image in accordance with the zooming operation or the panning operation when the detecting unit has detected at least either the zooming operation or the panning operation; and
a setting unit configured to set the second image as an image corresponding to at least one flame forming the time-lapse motion picture when the detecting unit has detected at least either the zooming operation or the panning operation in the mode,
wherein the second image is acquired at a different timing from the given timing for acquiring the first images.

2. The image capturing device according to claim 1, wherein when the detecting unit has detected at least either the zooming operation or the panning operation in the mode, the setting unit sets images acquired through the intermittent image capture and the second image as images corresponding to frames forming the time-lapse motion picture.

3. The image capturing device according to claim 1, wherein when the detecting unit has detected at least either the zooming operation or the panning operation in an image capture interval in the intermittent image capture, the acquiring unit causes the second image to be acquired.

4. The image capturing device according to claim further comprising a moving-image generating unit configured to generate the time-lapse motion picture,
wherein when the detecting unit has detected at least either the zooming operation or the panning operation in the image capture interval in the intermittent image capture, the moving-image generating unit generates the time-lapse motion picture by inserting a first image between, of the images acquired through the intermittent image capture, images acquired just before and just after timing at which the detecting unit has detected at least either the zooming operation or the panning operation.

5. The image capturing device according to claim 4, wherein when the detecting unit has detected at least either the zooming operation or the panning operation in the image capture interval in the intermittent image capture, the acquiring unit causes the multiple first images to be acquired.

6. The image capturing device according to claim 5, wherein when the detecting unit has detected at least either the zooming operation or the panning operation in the image capture interval in the intermittent image capture, the moving-image generating unit generates the time-lapse motion picture by combining images acquired through the intermittent image capture and a motion picture formed of the multiple first images.

7. The image capturing device according to claim 1, wherein
the given timing is a first image capture interval in which the intermittent image capture is performed, and
a first image is acquired in a second image capture interval shorter than the first image capture interval.

8. The image capturing device according to claim 1, further comprising a determining unit configured to determine whether or not an amount of the zooming operation or panning operation detected by the detecting unit is larger than a predetermined value,
wherein when the determining unit has determined that the amount of the zooming operation or the panning operation is larger than the predetermined value, the acquiring unit causes the first images to be acquired.

9. The image capturing device according to claim 1, further comprising a determining unit configured to determine whether or not an amount of the zooming operation or panning operation detected by the detecting unit is larger than a predetermined value,
wherein when the determining unit has determined that the amount of the zooming operation or the panning operation is larger than the predetermined value, the setting unit sets a first image as an image corresponding to at least one frame forming the time-lapse motion picture.

10. The image capturing device according to claim 8, wherein the determining unit determines whether or not an amount of the zooming operation a the panning operation in a time between start of the zooming operation or panning operation detected by the detecting unit and passage of a given time, is larger than the predetermined value.

11. The image capturing device according to claim 1, wherein when the detecting unit has detected the zooming operation or the panning operation in a time-lapse mode, the acquiring unit causes a first image to be acquired in accordance with image capturing conditions in the intermittent image capture before the zooming operation or the panning operation.

12. The image capturing device according to claim 11, wherein the image capturing conditions include at least one of focus position, exposure, and white balance.

13. A control method for an image capturing device that includes an image capturing unit and is able to set a mode to perform intermittent image capture, based on a predetermined given timing, to acquire multiple first images used for generation of a time-lapse motion picture, the control method comprising:
detecting at least either a zooming operation or a panning operation that is performed when an image of a subject is captured in the mode;
causing the image capturing unit to acquire a second image in accordance with the zooming operation or the panning operation when at least either the zooming operation or the panning operation has been detected; and
setting the second image as an image corresponding to at least one frame forming the time-lapse motion picture when at least either the zooming operation or the panning operation has been detected in the mode,
wherein the second image is acquired at a different timing from the given timing for acquiring the first images.

14. A computer-readable program for a computer to implement a control method for an image capturing device that includes an image capturing unit and is able to set a mode to perform intermittent image capture, based on a predetermined given timing, to acquire multiple first images used for generation of a time-lapse motion picture, the program causing the computer to execute:
detecting at least either a zooming operation or a panning operation that is performed when an image of a subject is captured in the mode;
causing the image capturing unit to acquire a second image in accordance with the zooming operation or the panning operation when at least either the zooming operation or the panning operation has been detected; and
setting the second image as an image corresponding to at least one flame forming the time-lapse motion picture when at least either the zooming operation or the panning operation has been detected in the mode,
wherein the second image is acquired at a different timing from the given timing for acquiring the first images.
